(19) United States
(12) Patent Application Publication
(10) Pub. No.: US 2019/0359468 A1
(43) Pub. Date: Nov. 28, 2019

(54) VALVE FOR FILLING AND EMPTYING A PRESSURISED PET CONTAINER

(71) Applicant: SABEV OU, Tallinn (EE)

(72) Inventor: Branislav BRKICH, Nasice (HR)

(21) Appl. No.: 16/477,674

(22) PCT Filed: Jul. 26, 2017
(86) PCT No.: PCT/IB2017/054545

§ 371 Date: Jul. 12, 2019

(30) Foreign Application Priority Data
Jan. 13, 2017 (IT) 102017000003618
May 29, 2017 (IT) 102017000058340

(51) Int. Cl. B67D 1/08; B67D 1/12

(52) U.S. Cl. CPC B67D 1/0832; B67D 1/125

(57) ABSTRACT

The present invention provides a valve device (1) for a container (100) for supplying and dispensing gaseous beverages, comprising a main valve body (1) connected to said container (100) by means of a connecting member (101), said main valve body (1) comprising a supplying and 0 dispensing port (10) of said beverages to/from said container (100), sealing means (2) arranged onto said dispensing port (10), elastic means (3) cooperating with said sealing means (2), beverage dispensing means (4) arranged internally to said main body (1), and pressure controlling means (5,40,41) for controlling a pressure threshold value within said container (100), the valve device it is characterized in that said dispensing means (4) and said pressure threshold value control means (5,40,41) comprises a single member (4,40,41) mounted in a movable manner inside said valve device (1), the arrangement being such that said dispensing means (4) are movable from a first position wherein they cooperate with said sealing means (2) for sealing the gaseous beverage within said container (100), and a second position wherein the gas is spilled out from the container (100) upon exceeding a preset threshold pressure value of gas within said container (100).

### DISCLOSURE

The present invention relates to a valve device for pressurised PET containers and, more specifically, to a valve device for the filling and the emptying of pressurised PET containers in food applications, such as gaseous beverage containers such as beer and similar.

### PRIOR ART

To date, several technologies are already known for the making of valves for the filling or the emptying of pressurised containers typically for food applications such as gaseous beverages.

For example, European Patent EP2450307B1 discloses a plastic keg container for containing gaseous beverages such as beer or the like, which includes a portion of neck and a body portion, the whole being enclosed in a shell. The container comprises a valve assembly associated with the container portion of the container, and the valve assembly provides a port having a head portion having a convex upper surface and at least a lower portion including a rod extending downwards from a lower surface. The rod comprises a stopping surface protruding radially outwardly beyond the head portion. A piston defines an opening. A spring urges the port against a peripheral part of the opening defined by the piston and in order to seal the upper convex surface of the head portion above the opening.

According to this document, although if the problem related to bulk and weights associated to the metal KEGs it is solved, there is a disadvantage due to the fact that the valve provides a complex structure, especially for what concerns to the control and the venting of overpressure.

In addition, US2013192691 discloses a recyclable valve for disposable beer containers (i.e. plastic) which it is characterized in that all its components are essentially made of polymeric material, so that it can be recycled without having to deal with the difficult and costly phase of differentiation of materials prior to their recycling.

This practical constructive solution nevertheless has the disadvantage of a low reliability given by that elastic parts (typically made of metal) are made of polymeric materials, and the operation thereof it is not always optimal, thus resulting in leakages in the seals.

Thus, the object of the present invention is to provide a valve device for the filling and the emptying of pressurised PET containers which solves the aforementioned disadvantages.

Another object of the present invention is to provide a valve device for the filling and the emptying of pressurised PET containers which has a simplified structure with respect to those of the relevant state of art.

It is a further object of the present invention to provide a valve device for the filling and the emptying of pressurised PET containers which can be used for different types of valves standards for pressurised PET containers.

### BRIEF DESCRIPTION OF THE INVENTION

Thus, the present invention provides a valve device for a PET container for containing and dispensing pressurized beverages, comprising a main valve body connected to said container by means of a connecting member, said main body having a supply and delivery port of said beverages to/from said container, sealing means cooperating with said port, elastic means cooperating with said sealing means, dispensing means for said beverages arranged internally to said main body, and means for controlling the maximum pressure within said container, the device being characterized in that said dispensing means and said maximum pressure controlling means comprises a single member mounted within said valve device in a movable manner, the arrangement being such that said dispensing means are movable between a first position wherein they cooperate with said sealing means for sealing the pressurized beverage within said container, and a second position wherein the pressurised gas is discharged from the container upon exceeding a pre-set gas pressure value within said container.

Thus, the present invention provides a valve device for the filling and the emptying of pressurised PET containers, substantially according to the appended claims.

### DETAILED DESCRIPTION OF THE INVENTION

A detailed description of some preferred embodiments of the valve device for the filling and the emptying of pressurised PET containers according to the present invention will now be provided, given by way of non-limiting example and with reference to the accompanying drawings, wherein:

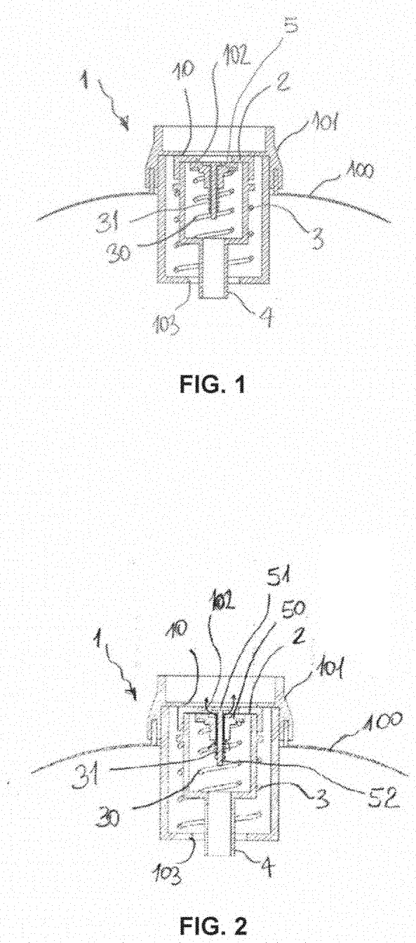

FIG. 1 is a schematic longitudinal sectional view illustrating a valve for pressurised beverage containers of the state of the art in a first operating condition;

FIG. 2 is a schematic longitudinal sectional view illustrating the valve of FIG. 1 in a second operating condition;

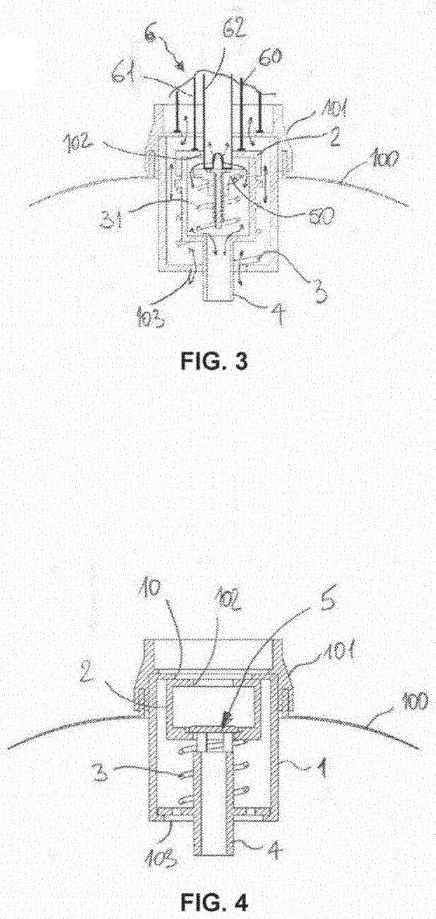

FIG. 3 is a schematic longitudinal sectional view illustrating the valve of FIG. 1 in a third operating condition;

FIG. 4 is a schematic longitudinal sectional view illustrating a first embodiment of the valve device for pressurised beverages container of the present invention in a first operating condition;

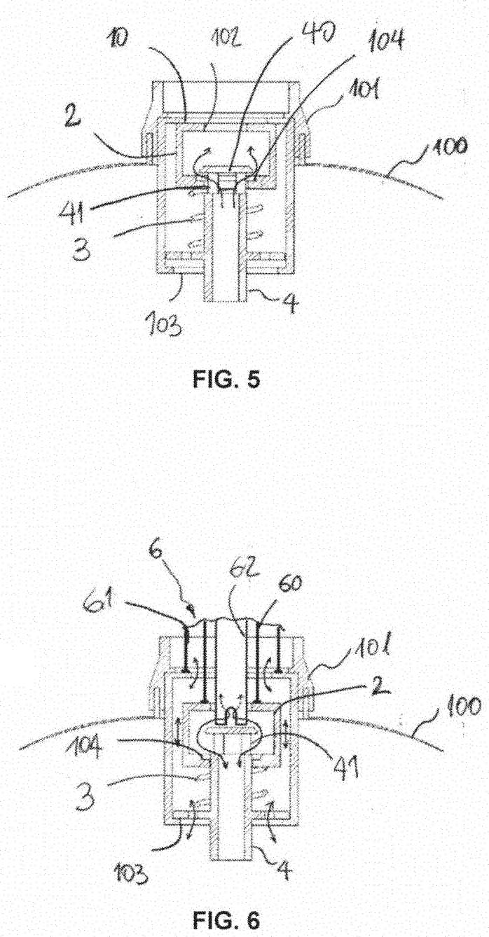

FIG. 5 is a schematic longitudinal sectional view illustrating the valve device of FIG. 4 in a second operating condition;

FIG. 6 is a schematic longitudinal sectional view illustrating the valve device of FIG. 4 in a third operating condition;

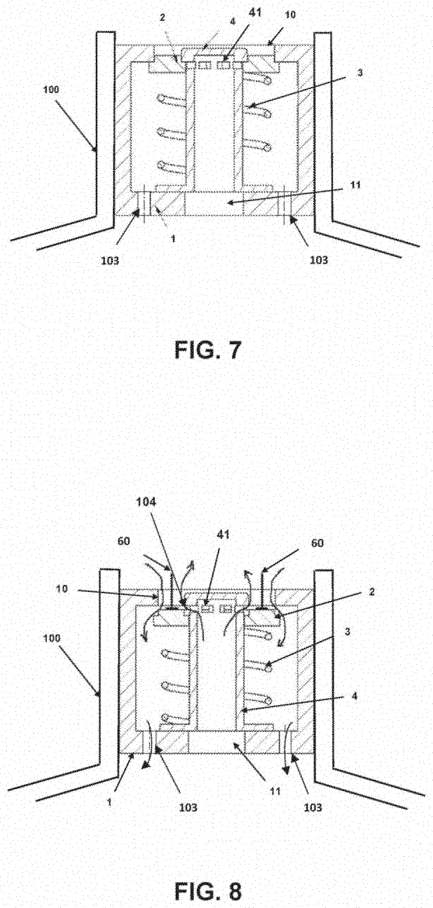

FIG. 7 is a schematic longitudinal sectional view illustrating a second embodiment of the valve device for pressurised beverages containers of the present invention in a first operating condition;

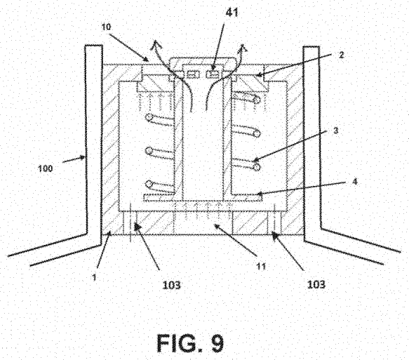

FIG. 8 is a schematic longitudinal sectional view illustrating the valve device of FIG. 7 in a second operational condition;

FIG. 9 is a schematic longitudinal sectional view illustrating the valve device of FIG. 7 in third operating condition;

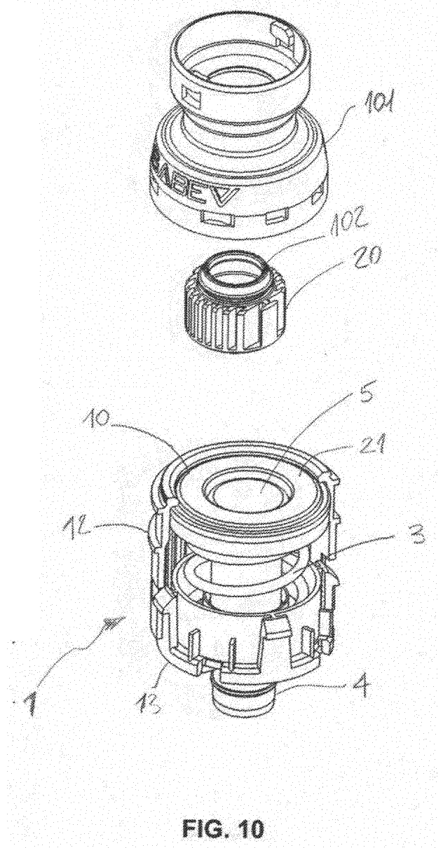

FIG. 10 is a perspective exploded view illustrating some components of the first embodiment of the valve device of the present invention;

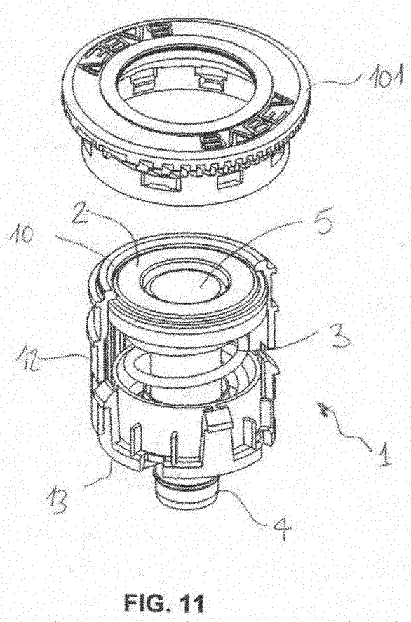

FIG. 11 is a perspective exploded view illustrating some components of the second embodiment of the valve device of the present invention;

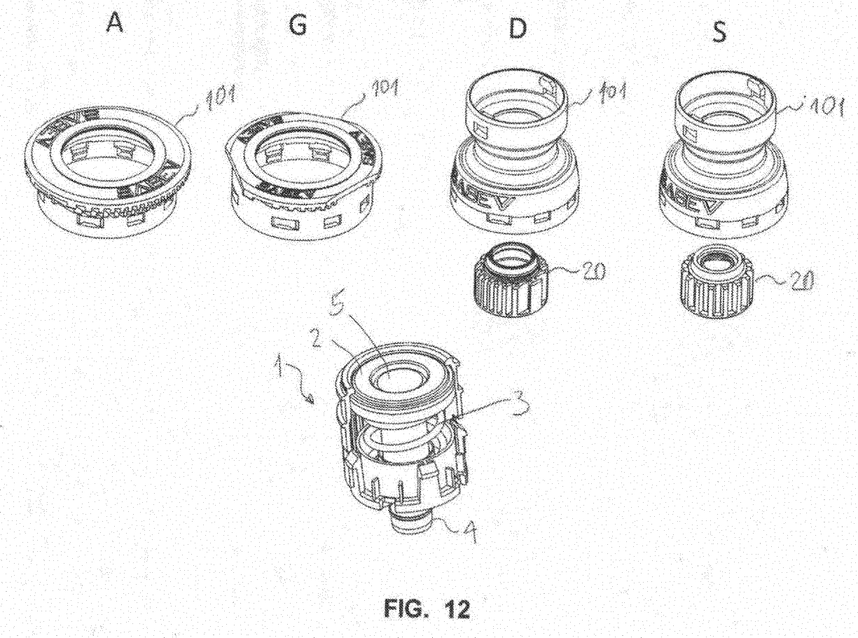

FIG. 12 is a schematic exploded perspective view illustrating some of the components of the valve device of the present invention according to the first and the second embodiments thereof; and

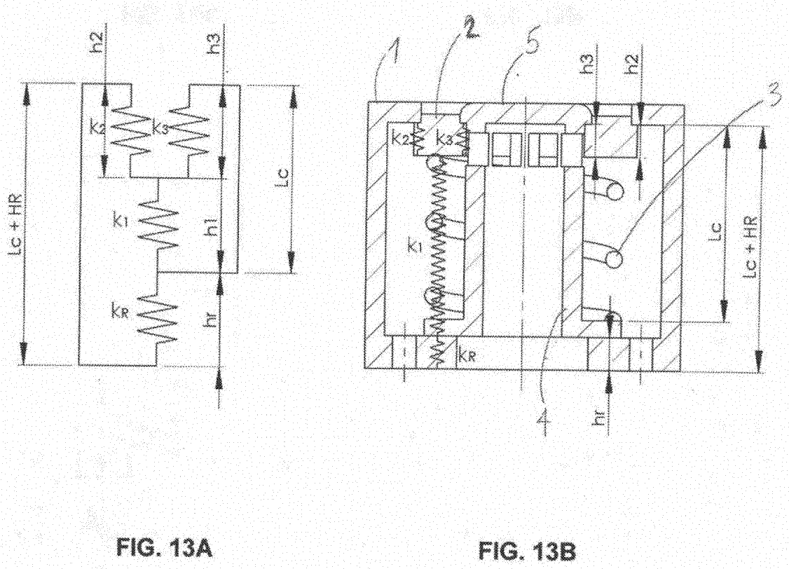

FIGS. 13A and 13B are schematic diagrams illustrating the elastic operating mechanism of the valve device of the present invention.

Referring now to FIGS. 1 and 2, there is schematically illustrated the operation of a valve typically applied to beer KEGs made of plastic material (PET) and according to the state of the art. It has to be noted here that the valve illustrated in FIGS. 1 and 2 is a valve “S” type for KEGs and according to state of the art.

Typically, such a valve device it is mounted at the neck portion of a KEG 1 at an upper port thereof. More specifically, the valve device comprises a main body 1 which it is connected to the upper part of the body neck of the KEG 100 by means of a connecting member 101 in the already known manner.

The main body 1 encloses the sealing system which is formed by a gasket 2 that abuts on a dispensing port 10 integrally formed on the main body 1, the stop being obtained by the action of a first helical spring 3 extending internally over the whole length of the main body 1.

At the central part of the main body 1 and coaxially to the helical spring 3 it is arranged in an axial movable manner a tubular member 4 which is held in abutment to the sealing member 2 and which communicates the inner volume of the KEG 100 with the outside through a second port 102 and an opening 103 formed on the inside of the part of the device body 1 which is within the volume of the container 100. In addition, internally to the tubular member 4 an internal pressure control device 5 of the container 100 it is mounted.

As will be better illustrated below, the internal pressure control device 5 foresees the automatic opening with the relevant pneumatic communication of the inner volume of the container 100 to the exterior upon reaching a predetermined threshold value (for example, the increase in the internal pressure following to the filling and the storage of the container 100 with a pressurized beverage).

The pressure control device 5 it is coaxially mounted inside the tubular member 4 and it is held in a abutting condition onto the port 102 by means of a second helical spring 30.

Thus, as it is apparent from the figure, both the tubular member 4 and the pressure control device 5 are axially movable within the main body 1 of the valve device, and against the action of the respective helical springs 3 and 30.

Referring now to FIG. 2, there is shown the operation of the internal pressure control device 5 of the prior art valve device as shown in FIG. 1.

According to this state of the art device, the internal pressure control device 5 of the container 100 is constituted by a supporting member 50 which supports a mushroom valve member 51 which has a rod 52 which it is coaxially connected to a third helical spring 31. The supporting member 50 abuts onto port 102 pneumatically sealing the latter, and under the action of the spring 30. The rod 52 of the valve 51 faces inside the tubular member 4, therefore being in a pneumatic communication with the inner volume of the container 100.

Upon reaching a predetermined pressure threshold value inside the container 100, the valve 51 rises against the action of the spring 31 causing a certain amount of gas to escape from the container 100 to the surrounding environment, and until reaching a lower threshold value wherein the spring 31 closes the valve 51.

Referring now to FIG. 3, it illustrates the operation of the valve of the state of the art and as illustrated in FIGS. 1 and 2.

For the supplying of the beverage, the valve 1 it is coupled to a coupling or dispensing device 6 (partially shown in the figure) which has a pair of delivery openings and 62 which are arranged coaxially (concentric) one with respect to the other, and being separated by a septum 60. The peripheral opening 61 is capable of delivering/supplying gas (typically CO2) inside the KEG, and in order to create the required pressure for the spontaneous dispensing of the beverage through the central opening 62 to dispense/receive the beverage from/into the container 100. During the beverage dispensing/refilling, the pressure control device 5 it is in a closed/locked condition by the joint device 6 itself.

In more detail, the coupling of the septum 60 to the seal 2 causes the latter to move under the action of the spring 3, lowering or moving towards the inside of the body 1. The displacement of the seal 2 causes the opening of the dispensing port 10. In addition, the opening 62 being protruded inwardly causes in turn the lowering of the member 50 inwards, and consequently the opening of the port 102. The ports 10 and 102 being opened bring in pneumatic communication the inner volume of the KEG container 100 with the openings 61 and 62 of the joint 6, thereby creating two preferential channels for the beverage and for the gas inlet and separated from the septum 60 (as illustrated by the arrows in the figure).

Injecting CO2 gas into the inside of the KEG 100 creates an internal pressure increase which in turn generates spontaneous beverage delivery to the outside of the KEG by a differential pressure between the internal volume of the KEG and the external environment.

With reference now to FIGS. 4 and 5 and 6, there is illustrated a first embodiment of the valve device of the present invention to be applied to PET containers containing gaseous beverages.

According to this first embodiment of the valve device of the present invention, the same it is applicable to a PET container according to the standard “S” valve type for containers or KEGs for gaseous beverages. It has to be noted here and as it will be better understood below, the valve device of the present invention can easily be applied to gaseous beverage containers or KEGs according to the standards of other valve models, i.e. “D” or “A” or “G” valves model types.

For the sake of clarity, same component parts will have the same numbers and the detailed description thereof will be here omitted since as it has already given.

With reference now to FIG. 4, it illustrates the valve device of the present invention applied to a KEG PET container 100.

According to the present invention, the valve device comprises a main body 1 which it is connected to the neck body of the KEG 100 by means of a connecting member 101 in the already known manner.

The main body 1 encloses the sealing system which consists of a sealing member 2 that abuts on a dispensing port 10 onto the main body 1, the closing of the port 10 is obtained by abutting the sealing member 2 by the biasing action of an helical spring 3 extending internally along the entire length of the main body 1. The sealing member 2 consisting of a box body connected to the tubular member 4.

At the central part of the main body 1 of the valve device and coaxially with the helical spring 3, the tubular member 4 it is mounted in an axially movable manner, the tubular member 4 being biased onto the sealing member 2 and communicates the internal volume of the KEG container 100 with the outer environment through a second port 102, and a third opening 103 it is formed on the inside of the body of the valve device 1, the opening 103 facing the inside volume of the KEG container 100.

In addition and as it will be shown in detail hereinafter, the tubular member 4 incorporates an internal pressure control device 5 for the KEG container 100. The pressure control device 5 foresees that upon reaching a predetermined threshold value (for example, the increase in internal pressure after the filling and/or the storage of the container 100 having a gaseous beverage therein) the same provides for automatic opening of the device 5 with the relative pneumatic communication of the inner volume of the KEG container 100 with the outside environment.

Referring now to FIG. 5, the pressure control device 5 it is obtained at the end part of the tubular member 4 which faces the outside environment. This end part of the tubular member 4 has a mushroom shaped part 40 having a plurality of ports 41. The part 40 it is held abutting onto a port 104 formed onto the sealing member 2 by the biasing of the helical spring 3 on the tubular member 4.

As it is apparent from the figure, the tubular member 4 and the pressure control device 5 which it is incorporated into the former are axially movable within the main body 1 of the valve device and against the action of the single helical spring 3.

For the operation of the internal pressure control device 5 of the container 100, upon reaching a predetermined threshold pressure value inside the KEG container 100, the part 40 it is raised from its seat onto the sealing member 2 and against the action of the spring 3, thereby communicating the plurality of ports 41 with the outer environment and spilling out to the environment a determined amount of gas coming from the KEG container 100, and until reaching a lower threshold pressure value wherein the spring 3 bias the part 40 onto the port 104 of the sealing member 2.

This process can be repeated whenever the internal pressure in the KEG 100 exceeds a predetermined value and according to the operating settings of the valve device 1 of the present invention.

Referring now to FIG. 6, there is schematically illustrated the operation of the valve device of the present invention during dispensing/filling of gaseous beverage from/to the KEG container 100.

For the operation, the beverage dispensing it is carried out by coupling the valve 1 to a dispenser device 6 in the manner already described above, namely by creating two preferred beverage/gas delivery channels inside the KEG 100 through the septum 60 which lowers the sealing member 2 under the action of the spring 3.

It is important to be noted here that during the use of the KEG, i.e. during the beverage dispensing and during the KEG washing, the movable tubular member 4 it is in the locked condition by being biased against the bottom of the valve body 1 (identical condition to that illustrated in FIG. 3), while the part 40 and the ports 41 are separated from the sealing member 2 by pneumatically communicating the inner volume of the container 100 with the gas dispensing opening 62 of the joint 6.

With reference now FIGS. 7 and 8 and 9, a detailed description of a second embodiment of the valve device of the present invention will now be provided as an application to a PET KEG container for gaseous beverage.

According to this second embodiment of the valve device of the present invention, the same it is applicable to a PET container according to the standard “A” or “G” of valve type for gaseous beverages containers.

For the sake of clarity, same component parts will have the same numbers and the detailed description thereof will be here omitted since already been given.

Referring now to FIG. 7, the valve device it is mounted at the neck portion of a KEG 100, and generally it comprises four components. More precisely, the main body 1 it is connected to the neck part of the KEG 100 in the already known manner (via a connecting member not shown in the figure).

The main body 1 encloses the sealing system which consists of a sealing member 2 which abuts onto a dispensing port 10 obtained in the main body 1 and against the action of an helical spring 3 extending along the entire length of the main body 1.

At the central part of the main body 1 and coaxially to the helical spring 3 it is axially arranged a tubular member 4 which communicates the inner volume of the KEG 100 with the external environment through a series of ports 41 obtained at the end part of the tubular member 4 and communicating with the inner part of the tubular member 4, the latter communicating with a port 11 formed onto the main body 1 at the body part which faces internally volume of the KEG 100.

With reference now to FIG. 8, the operation of the valve device of the present embodiment it is illustrated therein.

For the dispensing of the beverage, the valve 1 it is coupled to the dispensing device 6, the latter having a pair of concentric openings being separated by a septum 60 (only the septum 60 being shown in the figure). The central opening being adapted to dispense the beverage from the KEG 100, and the peripheral opening it is suitable for dispensing gas (typically CO2) inside the KEG 100 through the ports 103 obtained at the lower part of the body 1 of the valve device (i.e. the part that faces inside the volume of the container 100), and in order to create the necessary pressure for the spontaneous dispensing of the beverage from inside the KEG 100 to the outside.

In more detail, the coupling of the the septum 60 with the seal 2 causes the latter to move against the action of the spring 3 by lowering or moving the former towards the inside of the body 1. The moving of the seal 2 causes the opening of the dispensing port 10 and the ports 41 by communicating the inner volume of the KEG 100 with the outer environment, and creating thereby two dispensing channels both for the beverage and for the injected gas and separated from the septum 6 (as it illustrated by the arrows in the figure). The CO2 gas injection through the ports 103 to the inside of the KEG 100 causes a spontaneous dispensing of beverage towards the outside of the KEG 100 through the ports 41 and by means of pressure difference between the inner volume of the KEG 100 and the external environment.

It has to be noted here that during the use of the KEG 100, i.e. during the beverage dispensing and during the KEG scrubbing, the movable tubular member 4 it is in the locked condition by contacting the bottom part of the valve body 1.

Referring now to FIG. 9, it is schematically shown the operation of the valve device of the present invention when an overpressure occurs and typically applied to gaseous beverage KEGs.

The main body 1 houses inside thereof the sealing system made by the sealing member 2 which abuts onto the dispensing port 10 obtained on the main body 1 and against the action of the helical spring 3, the latter extending along the entire length of the main body 1.

At the central part of the main body 1 it is arranged the tubular member 4 mounted in a movable manner with respect to the main body 1 and according to the axial direction thereof.

In the case where an overpressure occurs within the KEG 100 (for example, when storing or transporting a filled KEG 100) and with the aim of preventing the reaching of threshold pressure values which could result in bursting of the KEG 100 (i.e., the pressure threshold values typically are about 8 Bar, and as predetermined for maximum permissible pressures according to current specifications and regulations), the arrangement of the present device provides that the tubular member 4 being movably mounted inside the main body 1 and coaxially to the helical spring 3, the first it is susceptible to move by the thrust of the pressure inside the KEG 100 (then upwards according to FIG. 9). The thrust of the internal pressure causes the tubular member 4 to move outside the valve body 1 against the action of the helical spring 3, and consequently communicating the openings 41 to the outer environment.

In this condition, the gas contained inside of the KEG 100 will be spilled outward thereby decreasing the internal pressure inside the KEG 100.

As the inner pressure inside the KEG 100 decreases, the spring 3 moves inwardly the tubular member 4 until closing the openings 41 onto the sealing member 2 and stopping the gas leak from the KEG 100.

This process can be repeated whenever the internal pressure inside the KEG 100 exceeds a predetermined pressure value and according to the operating settings of the valve device 1 of the present invention.

Referring now to FIG. 10, it shows a partially exploded and partially sectioned view of the structure of the first embodiment of the valve device of the present invention, in particular for standard applications conforming to valve type “D” or “S” type for gaseous beverages containers.

According the construction of the first embodiment of the valve device of the present invention, the main body 1 it is made by two parts 12 and 13, respectively interlocked together in a removable manner. In this way, it is possible to have access to the components enclosed within the main body 1. Further, the sealing member 2 comprises two removable components 20 and 21.

Referring now to FIG. 11, it shows a partially exploded and partially sectioned view of the structure of the second embodiment of the valve device of the present invention, conforming to the standards of “A” or “G” type valves for gaseous beverage containers.

According to second embodiment of the valve device of the present invention, the construction of the valve device provides that the main body 1 be made identical to the main body 1 of the first embodiment, i.e. in two parts 12 and 13 respectively interlocked together in a removable manner and which enclose the relevant components.

The only constructive difference from the first embodiment consists in that the sealing member 2 comprises only a single component since it must be compatible with the standard valve type “A” or “G”, as well as the connecting member 101 to the container.

With reference now to FIG. 12, the arrangement structure of the valve device according to the first and the second embodiments it is schematically and partially shown.

As it is apparent in the figure, advantageously and according to the present invention the main body 1 it is structural identical for all the different standards of valve types “A” or “G” or “D” or “S” for applications in gaseous beverages containers.

The only constructive variable between a valve model and other illustrated valve models consists of the presence or not of the further component 20 for the sealing member 2 and the relevant connecting member 101 which differs from each type of standard (i.e. type “A” or “G” or “D” or “S”).

According to the present invention this constructive solution has an enormous advantage for the valve manufacturer, and which consists in providing very small amount or number of different components for each type of valve application according to the “A” or “G” or “D” or “S” standards types.

In addition, the interchangeability of most of the components of all the valve device types of the present invention allows reducing the inventory with considerable savings on space and costs.

Referring now to FIGS. 13A and 13B, there is schematically illustrated therein the elastic operating mechanism of the valve device 1 of the present invention.

The system comprises several elastic parts in a static condition, and the static condition depending to the pressure values.

The kinematic model of the system it is illustrated in FIG. 13A as a set of springs arranged in series and/or in parallel, each of which represents a single component with its elastic constant k.

In FIG. 13A the helical spring 3 has been replaced by k1 associated with the physical dimension h1, the sealing member 2 it is represented by k2 and k3 associated with the physical dimension h2 and h3, respectively. The presence of two k2 and k3 constants it is due to the fact that they represent the two deformation points in contact with the other parts, and more precisely the abutting part onto the dispensing port 10 and the abutting part on the tubular member 5, respectively.

The constant kr indicates the reaction between body 1 and tubular member 4.

This modelling allows to study the behaviour of the device of the present invention as if it were a mechanical oscillator, and then study the behaviour of each component of the device during its operation (by setting the equations of physical and fluids dynamics already known by the man skilled in the art of pertinent art).

The parameterization of the components allows the optimum sizing of the various areas and/or flow passages of all the related fluids to ensure optimum fluid flow through the various components and thus the best possible performance of the device of the present invention and according to the predetermined standards.

In addition, it is possible to vary the functional performance of the device of the present invention depending on the “sizing” of each component of the device.

The device of the present invention has many advantages.

A first advantage is that the main body 1 it is structurally identical for all the different valve models (i.e., “A” or “G” or “D” or “S” valve types). This solution brings enormous advantage to the valve manufacturer to have a very small amount of different components for each type of valve application, and according to “A” or “G” or “D” or “S” standards, thanks to the possibility of interchanging the components constituting the main body 1 in each valve model, either “A” or “G” or “D” or “S”.

Another advantage lies in the extreme simplicity of the device structure with a very small number of components. This has the enormous advantage for the valve manufacturer in that a very small amount of different components for each type of valve application has to be provided according to “A” or “G” or “D” or “S” valve models.

Another advantage lies in the fact that only a single elastic member 3 (helical spring 3) it is provided to perform all the necessary functions, unlike the state of the art valve devices, where three elastic members of different sizes are provided. This entails the huge advantage for the valve manufacturer to have a very small amount of components, and being interchangeable for each type of valve application according to standards.

A further advantage is that due to the reduced number of components provided in the valve system of the present invention, which increases the reliability of the system, as the smaller the number of parts the less possibility of malfunctioning.

Furthermore, the interchangeability of most of the components of the valve device of the present invention, allows to reduce the inventory with considerable savings on spaces and costs.

Further, the device of the present invention it is designed in such a way as to be totally recyclable with extreme ease.

1. A valve device (1) for a container (100) for supplying and dispensing gaseous beverages, comprising a main valve body (1) connected to said container (100) by means of a connecting member (101), said main valve body (1) comprising a supplying and dispensing port (10) of said beverages to/from said container (100), sealing means (2) arranged onto said dispensing port (10), elastic means (3) cooperating with said sealing means (2), beverage dispensing means (4) arranged internally to said main body (1), and pressure controlling means (5,40,41) for controlling a pressure threshold value within said container (100)
characterized in that said dispensing means (4) and said pressure threshold value control means (5,40,41) comprises a single member (4,40,41) mounted in a movable manner inside said valve device (1), the arrangement being such that said dispensing means (4) are movable from a first position wherein they cooperate with said sealing means (2) for sealing the gaseous beverage within said container (100), and a second position wherein the gas is spilled out from the container (100) upon exceeding a preset threshold pressure value of gas within said container (100).

2. A valve device (1) for a container (100) for supplying and dispensing gaseous beverages according to claim 1, wherein said beverage dispensing means comprises a tubular member (4) it is movably mounted with respect to the main body (1) and being movable along the axial direction thereof.

3. A valve device (1) for a container (100) for supplying and dispensing gaseous beverages according to claim 2, wherein an end part of said tubular member (4) it is inserted into a sealing member (2) abutting said first dispensing port (10) formed in the main body (1), said sealing member (2) being biased by an helical spring (3) onto said first dispensing port (10), said helical spring (3) being coaxially mounted onto said tubular member (4).

4. A valve device (1) for a container (100) for supplying and dispensing gaseous beverages according to claim 3, wherein said tubular member (4) comprises a plurality of dispensing ports (41) obtained at one end part of said tubular member (4), said plurality of dispensing ports (41) pneumatically communicating the internal volume of the container (100) with the outer environment through a third port (104) in said sealing member (2) and through the opposite end of said tubular member (4) at the part of the valve body (1) which faces internally into the volume of the container (100).

5. A valve device (1) for a container (100) for supplying and dispensing gaseous beverages according to claim 4, wherein during the beverage dispensing from the container (100) said sealing member (2) it is in a condition spaced from said first dispensing port (10) against the action of said helical spring (3), and said movable tubular member (4) being in a locked condition at the valve body portion (1) which faces internally the volume of the container (100), the arrangement being such that said dispensing port (10) pneumatically communicates the inner volume of said container (100) and said plurality of dispensing ports (41) pneumatically communicate the inner volume of said container (100) with the third port (104).

6. A valve device (1) for a container (100) for supplying and dispensing gaseous beverages according to claim 1, wherein when the gas pressure value inside the container (100) reaches said predetermined threshold value, said tubular member (4) it is moved under the action of said gas pressure and against the action of said spring (3) by opening said port (104) onto said sealing member (2) and bringing said plurality of ports (41) to a condition wherein the inner volume of the container (100) pneumatically communicate with the outside environment.

7. A valve device (1) for a container (100) for supplying and dispensing gaseous beverages according to claim 1, wherein said sealing member (2), said helical spring (3), and said tubular member (4) are mounted in a coaxial arrangement one with respect to the other inside said valve body (1) and to the said dispensing discharge port (10).

8. A valve device (1) for a container (100) for supplying and dispensing gaseous beverages according to claim 7, wherein said sealing member (2) seals both said first dispensing port (10) on said valve body (1) and said plurality of dispensing ports (41) on said tubular member (4) simultaneously and under the action of said spring (3).

9. A valve device (1) for a container (100) for supplying and dispensing gaseous beverages according to claim 8, wherein said sealing member (2) comprises a part (20) made of a box member connected to said tubular member (4).

10. A valve device (1) for a container (100) for supplying and dispensing gaseous beverages according to claim 1, wherein said main body (1) comprises two parts (12, 13) respectively connected one to the other in a removable manner.

11. A valve device (1) for a container (100) for supplying and dispensing gaseous beverages according to claim 1, wherein said valve device it is made of a plastic material except for said elastic means (3).
